(19) United States
(12) Patent Application Publication
(10) Pub. No.: US 2010/0251352 A1
(43) Pub. Date: Sep. 30, 2010

(54) System and method for rendering a set of program instructions as executable or non-executable

(75) Inventors: Richard R. Zarchy, Crystal Lake, IL (US); Stephen W. Harpe, Vernon Hills, IL (US); Jeffrey B. Grier, Royal Oak, MI (US); Michael Anthony Carroll, Douglas (IE); Dylan Josef Fairbairn, Kilworth (IE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated, Kenosha, WI (US)

(21) Appl. No.: 12/410,113

(22) Filed: Mar. 24, 2009

(51) Int. Cl. H04L 9/32

(52) U.S. Cl. 726/9

(57) ABSTRACT

A method and system for rendering a set of computer-readable program instructions on a user device as executable or non-executable. The user device or an intermediary device may transmit an access-token request including a device identifier to a server device. The server device determines whether the device identifier matches a registered device identifier, and if so, transmits an access-token to the user device, or to the intermediary device, which in turn transmits the access-token to the user device. The access-token includes an expiration indicator. Preferably, the expiration indicator is not expired when received by the user device, but expires some time after being received by the user device. The user device executes a first set of program instruction to determine whether the expiration indicator is expired, and if so, renders a second set of program instructions as non-executable, otherwise the second set of program instructions are rendered as executable.

### BACKGROUND

Each year, over the past several years, vehicle manufacturers have built millions of motor vehicles, such as automobiles, motorcycles, farm machines (e.g., tractors and combines), and semi-tractors. After being manufactured, these vehicles occasionally require service so as to maintain and/or improve their operation. Since many, if not all, of these vehicles are complex machines, some types of vehicle service may occur only through the use of specialized tools. As an example, these specialized tools may include (i) engine repair tools, such as piston ring compressors and valve spring compressors, and (ii) vehicle diagnostic devices, such as MODIS (Modular Diagnostic Information System) devices manufactured by Snap-on Incorporated, Kenosha, Wis., U.S.A.

In one respect, a vehicle may be serviced by a technician working at a manufacturer-authorized repair center, such as the repair center of a retailer that sells new vehicles. In some cases, in accordance with an agreement between a vehicle manufacture and the retailer, the retailer may be required to purchase the specialized tools required for servicing the vehicles sold by the retailer. The purchase of these specialized tools during a given year or during several years may end up being a substantial investment for the vehicle retailer.

In another respect, a vehicle may be serviced by the owner of the vehicle or by a technician working at an independent repair center. Since the vehicle owner and the independent technician may not need a given specialized tool as frequently as a technician working at a manufacturer-authorized repair center, the independent technician and vehicle owner may not want to purchase the given specialized tool. Fortunately for independent technicians and vehicle owners, some enterprises, such as sellers of after-market parts, may rent or loan specialized tools to its customers. These sellers, however, take the risk that its customers will keep or steal the tools.

### SUMMARY

The exemplary embodiments described herein may be carried out to deter theft of any of a variety of user devices (e.g., specialized tools). These user devices may be rented or loaned to a given person or entity.

In one respect, an exemplary embodiment may take the form of a method carried out at a user device comprising a data storage device containing a first set of computer-readable program instructions and a second set of computer-readable program instructions. The exemplary method includes (i) the user device receiving a first access-token that includes an expiration indicator, (ii) after receiving the first access-token, the user device executing the first set of program instructions to determine that the expiration indicator is not expired and to responsively render the second set of program instructions as executable, and (iii) thereafter, the user device executing the first set of program instructions to determine that the expiration indicator is expired and to responsively render the second set of program instructions as non-executable.

In another respect, an exemplary embodiment may take the form of a user device comprising (i) a communications interface operable to receive an access-token that includes an expiration indicator, (ii) a data storage device that contains a first set of computer-readable program instructions and a second set of computer-readable program instructions, and (iii) a processor that is operable to execute the first set of program instructions and the second set of program instructions. The first set of program instructions includes program instructions that cause the processor to determine whether the expiration indicator is expired, to render the second set of program instructions as executable if the processor determines that the expiration indicator is not expired, and to render the second set of program instructions as non-executable if the processor determines that the expiration indicator is expired.

In another respect, an exemplary embodiment may take the form of a method carried out at a server device comprising a data storage device. The exemplary method includes (i) at the data storage device, maintaining at least one registered device identifier, (ii) the server device receiving a first access-token request including a first device identifier that identifies a first remote device, (iii) the server device determining that the first device identifier matches a registered device identifier being maintained at the data storage device, and (iv) after the server device determines that the first device identifier matches a registered device identifier being maintained at the data storage device, the server device generating an access-token including an expiration indicator, and thereafter transmitting the generated access-token to a communications network for transmission, in turn, to the first remote device.

In another respect, an exemplary embodiment may take the form of a server device comprising (i) a processor, (ii) a data storage device that contains computer-readable program instructions and at least one registered device identifier, and (iii) a communications interface that is operable to receive a first access-token request including a first device identifier. The first device identifier identifies a first remote device. The computer-readable program instructions comprise program instructions that are executable by the processor to (i) determine that the first device identifier matches a registered device identifier contained at the data storage device, and responsively generate a first access-token that includes an expiration indicator, and (ii) cause the communications interface to transmit the first access-token to a communications network for transmission, in turn, to the first remote device.

In another respect, an exemplary embodiment may take the form of a method carried out at an intermediary device that interfaces to a user device and to a server device. The exemplary method includes (i) the intermediary device obtaining a device identifier that identifies the user device, (ii) the intermediary device transmitting to the server device an access-token request including the device identifier that identifies the user device, and a device identifier that identifies the intermediary device, (iii) the intermediary device receiving from the server device an access-token including an expiration indicator, and (iv) the intermediary device transmitting the access-token including the expiration indicator to the user device. The user device uses the expiration indicator to determine whether a set of computer-readable program instructions maintained at the user device should be rendered as executable or as non-executable.

In another respect, an exemplary embodiment may take the form of an intermediary device comprising (i) a communications interface that interfaces to a user device and to a server device, (ii) a processor, and (iii) a data storage device that contains a first device identifier and computer-readable program instructions that are executable by the processor. The first device identifier identifies the intermediary device. The computer-readable program instructions include instructions that (i) cause the processor to determine a second device identifier that identifies the user device, (ii) cause the communications interface to transmit to the server device the first device identifier, the second device identifier, and an access-token request, and (iii) cause the communications interface to transmit to the user device an access-token that is received by the communications interface after the communications interface transmits to the server device the access-token request. The received access-token includes an expiration indicator. The user device uses the expiration indicator to determine whether a set of computer-readable program instructions maintained at the user device should be rendered as executable or as non-executable.

These as well as other aspects and advantages will become apparent to those of ordinary skill in the art by reading the following detailed description, with reference where appropriate to the accompanying drawings.

### BRIEF DESCRIPTION OF DRAWINGS

Various examples of embodiments arranged as a method or a system are described herein with reference to the following drawings, in which:

FIGS. 1 and 2 are block diagrams of exemplary systems in accordance with exemplary embodiments;

FIG. 3 illustrates an exemplary an access-token request;

FIG. 4 illustrates an exemplary access-token;

FIG. 5 is a block diagram of an exemplary user device;

FIGS. 6 and 7 illustrate details of the exemplary user device;

FIG. 8 is a block diagram of an exemplary server device;

FIG. 9 is a block diagram of an exemplary intermediary device; and

FIGS. 10, 11, and 12 are flow charts illustrating sets of functions that may be carried out via exemplary embodiments.

### DETAILED DESCRIPTION

### 1. Overview

This description describes exemplary methods and systems for rendering a set of computer-readable program instructions on a user device as executable and thereafter as non-executable. For a situation in which a user borrows or rents the user device from a given person or entity, once the set of computer-readable program instructions are rendered as non-executable, the usefulness of the user device to the user is reduced. In this way, the user may be more compelled to return the user device to the given person or entity. By way of example, the given person may be a person that works at an after-market automobile-parts store and/or at an entity that rents electronic user devices. In this way, the given entity may be the after-market automobile parts store and/or the entity that rents electronic user devices.

In accordance with an exemplary embodiment, the user device may receive an access-token including an expiration indicator. After receiving the access-token, the user device may execute a first set of program instructions to determine whether the expiration indicator is expired. If the user device determines that the expiration indicator is not expired, then the user device may responsively render a second set of program instructions as executable. On the other hand, if the user device determines that the expiration indicator is expired, then the user device may responsively render the second set of program instructions as non-executable.

While the second set of program instructions are non-executable, execution of the first set of program instructions may also cause the user device to display a message that indicates that the second set of program instructions are non-executable. Execution of the first set of program instructions to determine whether the expiration indicator is expired may be carried out in response to the user device receiving the access-token, in response to the user device powering to an on-state from an off-state, and periodically while the user device is powered up in the on-state (e.g., every 10 minutes).

### 2. Exemplary Architecture

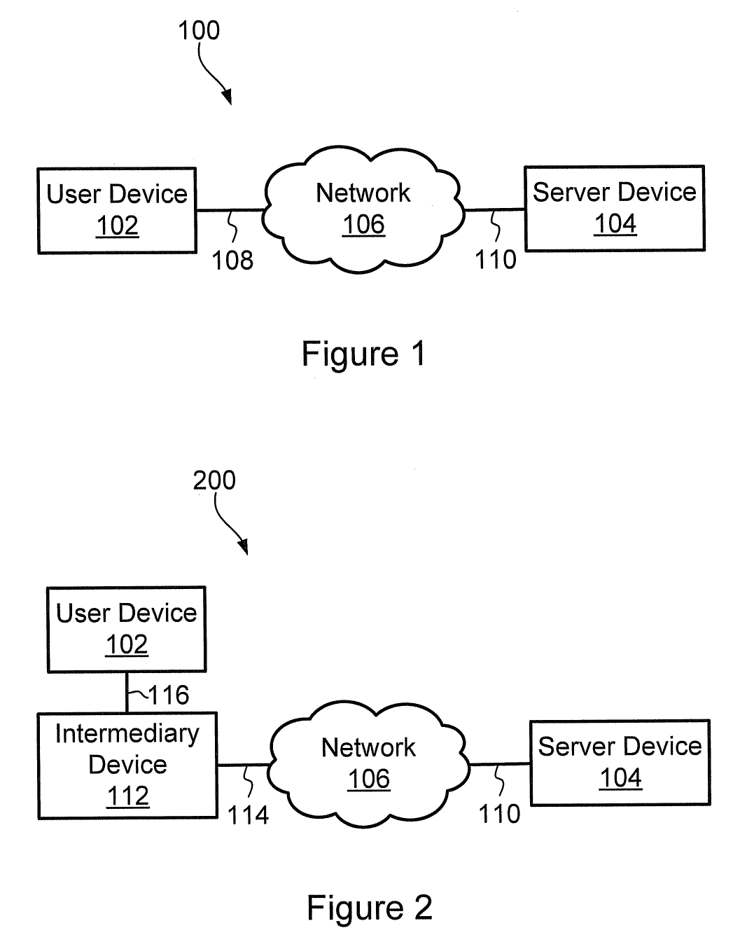

FIG. 1 is a block diagram of an exemplary system 100 in accordance with an exemplary embodiment. It should be understood that the arrangement of system 100 and other arrangements illustrated and/or described herein are set forth only as examples. Those skilled in the art will appreciate that other arrangements and elements (e.g., machines, interfaces, functions, orders, and groupings of functions, etc.) can be used instead, and that some elements may be omitted altogether. Many of the elements described herein are functional entities that may be implemented as discrete or distributed components or in conjunction with other components, and in any suitable combination and location. Various functions described herein as being performed by one or more elements may be carried out by hardware, firmware, and/or software (e.g., computer-readable program instructions that are stored at a data storage device and executable by a processor). For purposes of this description, the word “exemplary” is used to mean “serving as an example, instance, or illustration.” Any embodiment or element described herein as “exemplary” is not necessarily to be construed as preferred or advantageous over other embodiments or elements.

As illustrated in FIG. 1, system 100 includes a user device 102, a server device 104, network 106, and communication links 108, 110. Communication link 108 may operatively couple user device 102 to network 106. Communication link 110 may operatively couple server device 104 to network 106. Communication link 108 and/or communication link 110 may include and/or operate as an access network to network 106. Network 106 may include a packet-switched network and/or a circuit switched network. Network 106 may include the Internet.

Communication links 108, 110 may each comprise one or more wired communication links and/or one or more wireless communication links. A wired communication link may, for example, include a coaxial cable, a fiber optic cable, a twisted-pair of copper wires, a Universal Serial Bus (USB) cable, a TI line, or a public switched telephone network (PSTN) local loop. A wireless communication link may include an air interface that operates according to a wireless protocol or standard, such as (i) an IEEE 802.11 standard, such as IEEE 802.11b or 802.11g, (ii) the Bluetooth standard, (iii) the IEEE 802.16 (WiMax) standard, or (iv) a code division multiple access (CDMA) standard, such as IS-95. Other examples of wired and wireless communication links are also possible.

User device 102 may comprise any of a variety of devices. For example, user device 102 may comprise a hand-held diagnostic device, such as a MODIS, or a non-hand-held diagnostic device, such as automotive diagnostic device located within a desktop computer on a portable cart. User device 102 is not limited to diagnostic tools. In alternative embodiments, user device 102 may include a television, a digital video recorder and/or player, or a digital audio recorder and/or player (e.g., an MP3 recorder and player). Other examples of user device 102 are also possible.

Server device 104 may comprise any of a variety of devices. For example, server device 104 may comprise a personal computer that executes an operating system, such as the Windows XP operating system produced by Microsoft Corporation, Redmond, Wash., U.S.A. The personal computer may comprise a desktop personal computer manufactured by Dell Inc., Round Rock, Tex., U.S.A. As another example, server device 104 may comprise a workstation manufactured by Sun Microsystems Inc., Santa Clara, Calif., U.S.A. Other examples of server device 104 are also possible.

User device 102 may include a first set of program instructions and a second set of program instructions. User device 102 may transmit an access-token request to network 106 for transmission, in turn, to server device 104. In response to receiving the access-token request, server device 104 may generate and then transmit to network 106 an access-token including an expiration indicator. Network 106 may transport the access-token to communication link 108 for transmission, in turn, to user device 102. After receiving the access-token, user device 102 may execute the first set of program instructions (or at least a portion of the first set of program instructions) so as to determine whether the expiration indicator is expired. Based on the determination, user device 102 may thereafter render the second set of program instructions as executable or non-executable.

Next, FIG. 2 is block diagram of an exemplary system 200 in accordance with another exemplary embodiment. As illustrated in FIG. 2, system 200 includes user device 102, server device 104, network 106, an intermediary device 112, and communication links 110, 114, 116. Communication link 114 may comprise one or more wired communication links and/or one or more wireless communication links that operatively couple intermediary device 112 to network 106. Communication link 116 may comprise one or more wired communication links and/or one or more wireless communication links that operatively couple user device 102 to intermediary device 112.

Intermediary device 112 may comprise any of a variety of devices. For example, intermediary device 112 may comprise a personal computer that executes an operating system such as the Windows XP operating system described above. The personal computer may comprise a desktop personal computer manufactured by Dell Inc., Round Rock, Tex., U.S.A. As another example, intermediary device 112 may comprise a workstation manufactured by Sun Microsystems Inc., Santa Clara, Calif., U.S.A. Other examples of intermediary device 112 are also possible. Intermediary device 112 may be located at any of a variety of locations, such as an after-market automobile-parts store and/or the location of the entity that rents electronic user devices.

Intermediary device 112 may transmit an access-token request to network 106 for transmission, in turn, to server device 104. In response to receiving the access-token request, server device 104 may generate an access-token including an expiration indicator. Thereafter, server device 104 may transmit the access-token to network 106 for transmission, in turn, to intermediary device 112. Intermediary device 112 may then transmit the expiration indicator with or without the rest of the access-token to user device 102. After receiving the access-token, user device 102 may execute the first set of program instructions (or at least a portion of the first set of program instructions) so as to determine whether the expiration indicator is expired. Based on the determination, user device 102 may thereafter render the second set of program instructions as executable or non-executable.

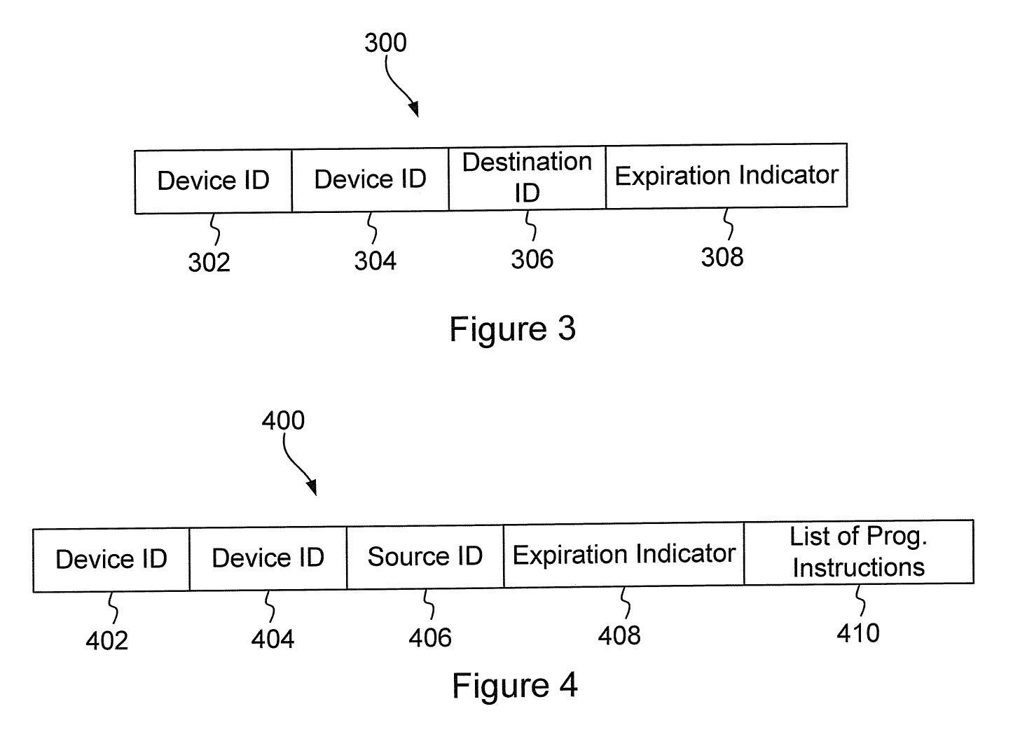

Next, FIG. 3 illustrates an exemplary access-token request 300 that may be generated, for example, by user device 102 or intermediary device 112, and thereafter transmitted to server device 104. As illustrated in FIG. 3, access-token request 300 includes device identifiers 302, 304, a destination identifier 306, and an expiration indicator 308. A person having ordinary skill in the art will understand that identifiers 302, 304, 306, and indicator 308, may be arranged in various positions within access-token request 300, and that identifiers 302, 304, 306, and indicator 308, may be contained within one or more data packets arranged in accordance with one or more protocols, such as the Transmission-Control-Protocol/Internet-Protocol (TCP/IP).

Device identifier 302 may comprise an identifier of user device 102. As an example, device identifier 302 may comprise any one or more of the following identifiers that identify and/or that are associated with user device 102: (i) an IP address, (ii) a media access control (MAC) address, (iii) a personal identification number (PIN), (iv) a user name and password, (v) a uniform resource locator (URL) for a given network domain, (vi) a disc drive serial number, and (vii) a license number.

The given network domain may represent a physical address (e.g., an IP address) of where user device 102 is located or accessing network 106. As an example, the URL may include the following sets of bracketed characters [www], [snap-on], and [com], and a period between each set of bracketed characters.

The license number may be a license number that uniquely identifies user device 102 and one or more sets of program instructions that are executable by processor 500. The identified sets of program instructions may be arranged as applications executable by processor 500. The identified sets of program instructions may be contained within program instructions 510, 512.

Device identifier 302 may include a permanent identifier (e.g., an identifier that does not change unless a hardware portion of user device 102 is changed). Alternatively, device identifier 302 may include a non-permanent identifier that may be changed periodically (e.g., a dynamically assigned IP address). Other examples of device identifier 302 are also possible.

Device identifier 304 may comprise an identifier of intermediary device 112. As an example, device identifier 304 may comprise any one or more of the following identifiers that identify and/or are associated with intermediary device 112: (i) an IP address, (ii) a media access control (MAC) address, (iii) a personal identification number (PIN), (iv) a user name and password, (v) a uniform resource locator (URL) for a given network domain, (vi) a disc drive serial number, and (vii) a license number (e.g., the license number within device identifier 302).

The given network domain may represent a physical address (e.g., an IP address) of where intermediary device 112 is located or accessing network 106. As an example, the URL may include the following sets of bracketed characters [www], [snap-on], and [com], and a period between each set of bracketed characters, or some other URL.

Device identifier 304 may include a permanent identifier (e.g., an identifier that does not change unless a hardware portion of intermediary device 112 is changed). Alternatively, device identifier 304 may include a non-permanent identifier that may be changed periodically. Other examples of device identifier 304 are also possible.

If access-token request 300 is generated by intermediary device 112, then prior to generating access-token request 300, intermediary device 112 may receive from user device 102 a device identifier of user device 102. Intermediary device 112 may insert the received device identifier into access-token request 300. On the other hand, if access-token request 300 is generated by user device 102, then user device 102 may receive a device identifier of intermediary device 112 from intermediary device 112. Alternatively, user device 102 may omit device identifier 304 or fill the device identifier 304 with null characters (e.g., zeros).

Device identifier 302 or device identifier 304 may be used as a source identifier of access-token request 300. For example, an IP address of user device 102 or of intermediary device 112 may be used as the source identifier. Alternatively, access-token request 300 may include a separate source identifier (not shown).

Destination identifier 306 may comprise an identifier of the destination to which access-token request 300 is transmitted. As an example, destination identifier 306 may comprise an IP address of server device 104.

Expiration indicator 308 may comprise any of a variety of computer-readable identifiers that allow user device 102 to determine whether expiration identifier 308 is expired, and/or whether a second set of program instructions on user device 102 should be rendered as executable or as non-executable. As an example, expiration identifier 308 may comprise data that represents an amount of time (e.g., 72 hours, 4,320 minutes, or 259,200 seconds), a time of day (e.g., 11:59 PM), a calendar date (e.g., Jun. 26, 2009), or any combination of the amount of time, the time of day, and the calendar date. Preferably, expiration indicator 308 comprises the expiration indicator that was received most recently at user device 102. Expiration indicator 308 may or may not be expired at the time access-token request 300 is transmitted to server device 104. Other examples of expiration indicator 308 are also possible.

Next, FIG. 4 illustrates an exemplary access-token 400. As illustrated in FIG. 4, access-token 400 includes device identifiers 402, 404, source identifier 406, an expiration indicator 408, and a list of computer-readable program instructions 410. A person having ordinary skill in the art will understand that identifiers 402, 404, 406, expiration indicator 408, and list 410 may be arranged in various sequences, and that identifiers 402, 404, 406, expiration indicator 408, and list 410 may be contained within one or more data packets arranged in accordance with one or more protocols, such as TCP/IP.

Device identifier 402 may identify user device 102, and may be arranged as device identifier 302. Device identifier 404 may identify intermediary device 112, and may be arranged as device identifier 304. Source identifier 406 may identify the device that generates access-token 400. As an example, source identifier 406 may comprise an IP address of server device 104. Device identifier 402 or device identifier 404 may be used as a destination identifier of access-token 400. Alternatively, access-token 400 may include a separate destination identifier (not shown), such as an IP address of user device 102 or of intermediary device 112.

Expiration indicator 408 may comprise any of a variety of computer-readable identifiers that allow user device 102 to determine whether expiration identifier 408 is expired, and/or whether a second set of program instructions on user device 102 should be rendered as executable or as non-executable. As an example, expiration identifier 408 may comprise data that represents an amount of time (e.g., 72 hours, 4,320 minutes, or 259,200 seconds), a time of day (e.g., 11:59 PM), a calendar date (e.g., Jul. 12, 2009), or any combination of the amount of time, the time of day, and the calendar date. Other examples of expiration indicator 408 are also possible.

In accordance with an exemplary embodiment, user device 102 may render the second set of program instructions as executable for a predetermined amount of time. A time of day indicated by expiration identifier 408 may, for example, indicate the time of day when server device 104 receives access-token request 300 or when server device 104 generates access-token 400. A calendar date indicated by expiration identifier 408 may, for example, indicate the calendar date on which server device 104 receives access-token request 300 or the date on which server device 104 generates access-token 400. In this way, if the predetermined amount of time is 3 days and if user device 102 receives an expiration identifier 408 that indicates a time of day of 10:34 AM and a calendar date of Jul. 12, 2009, user device 102 may responsively render the second set of program instructions as non-executable at 10:34 AM on Jul. 15, 2009.

The list of program instructions 410 may comprise a list of computer-readable program instructions contained at user device 102. The list of program instructions may be arranged as or as part of a text file or an extensible markup language (XML) file. A processor of user device 102 may read the list 410 to determine which program instructions contained at user device 102 are the set of program instructions rendered as executable or non-executable depending on whether the expiration indicator 408 is expired. In this regard, server device 104 may change which program instructions stored at user device 102 are considered to be the second set of program instructions by changing the list of program instructions 410 that are included within a given access-token.

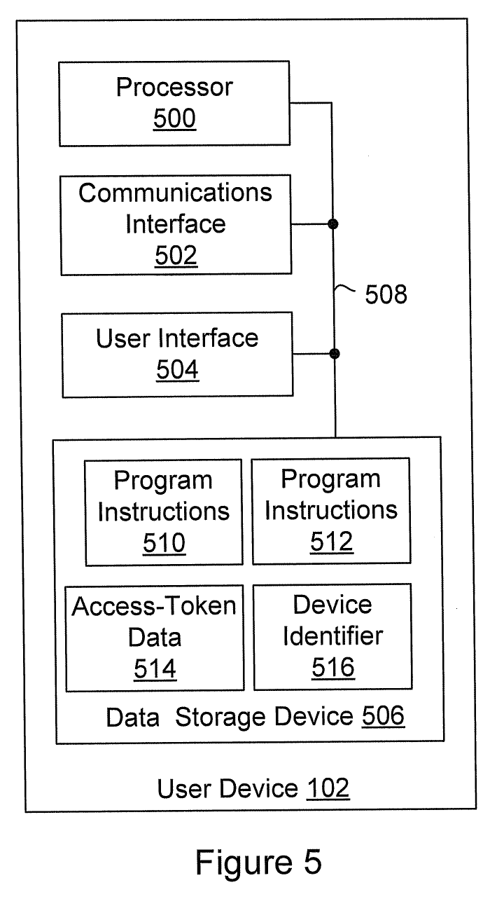

Next, FIG. 5 is a block diagram illustrating details of user device 102. As illustrated in FIG. 5, user device 102 includes a processor 500, a communications interface 502, a user interface 504, and a data storage device 506, all of which may be linked together via a system bus, network, or other connection mechanism 508.

Processor 500 may comprise one or more general purpose processors (e.g., INTEL microprocessors) and/or one or more special purpose processors (e.g., digital signal processors). Processor 500 may execute computer-readable program instructions stored at data storage device 506.

Communication interface 502 may connect to various networks and/or devices. For example, communications interface 502 may connect to network 106 via communication link 108. As another example, communications interface 502 may connect to intermediary device 112 via communications link 114.

Communications interface 502 may carry out various communications, and may include a network interface card (NIC) to do so. For example, communications interface 502 may carry out communications by (i) transmitting access-token request 300 to intermediary device 112 via communication link 116, (ii) transmitting access-token request 300 to communications link 108 for transmission, in turn, to server device 104 via network 106, and (iii) transmitting access-token 300 to server device 104 via a communication link (e.g., a USB link) that connects communications interface 502 directly to server device 104. As another example, communications interface 502 may carry out communications by receiving audio content (e.g., MP3 audio content) and/or video content (e.g., MPEG video content) from a content provider (e.g., server device 104).

Processor 500 may execute program instructions that cause communications interface 502 to generate and/or transmit access-token request 300. In response to transmitting access-token request 300, communications interface 502 may receive access-token 400 from a remote device, such as server device 104 or intermediary device 112. In response to receiving the access-token, communications interface 502 may provide the access-token to processor 500.

Data storage device 506 comprises a computer-readable storage medium readable by processor 500. The computer-readable storage medium may comprise volatile and/or non-volatile storage components, such as optical, magnetic, organic or other memory or disc storage, which can be integrated in whole or in part with processor 500.

Data storage device 506 may contain various data. For example, data storage device 506 may contain a first set of computer-readable program instructions 510, a second set of computer-readable program instructions 512, access-token data 514, and a device identifier 516 that identifies user device 102. Device identifier 516 may be arranged as device identifier 302 and/or device identifier 402.

Access-token data 514 may comprise at least a portion of one or more access-tokens generated by server device 104. Access-token data 514 may include at least a portion of access-token 400, such as expiration indicator 408. Access-token data 514 may also include an expired expiration indicator. For example, access-token data 514 may include an expiration indicator that was generated by and received from server device 104 prior to user device 102 generating access-token request 300. The expiration indicator 308 may comprise an expired expiration indicator stored as access-token data 514.

Program instructions 510 may comprise various program instructions. As an example, program instructions 510 may include instructions that cause processor 500 to determine whether expiration indicator 408 is expired, to render program instructions 512 as executable if processor 500 determines that expiration indicator 408 is not expired, and to render the program instructions 512 as non-executable if processor 500 determines that expiration indicator 408 is expired.

As another example, program instructions 510 may include instructions that are executable by processor 500 to cause user interface 504 to display a message that indicates program instructions 512 are rendered as executable, and other instructions that are executable by processor 500 to cause user interface 504 to display a message that indicates program instructions are rendered as non-executable.

Program instructions 512 may comprise various program instructions depending on the intended purpose of user device 102. In accordance with an embodiment in which user device 102 comprises a hand-held or non-hand-held diagnostic device, program instructions 512 may, for example, comprise any of the following program instructions: (i) program instructions for servicing a vehicle that transports one or more persons, such as an automobile, a motorcycle, a sport-utility vehicle, or a semi-tractor, (ii) program instructions for displaying vehicle diagnostic trouble codes and diagnostic parameters, (iii) program instructions for operating a multi-meter that measures electrical parameters such as resistance, current, and voltage, and (iv) program instructions for operating an oscilloscope within user device 102.

In accordance with an embodiment in which user device 102 comprises a television, program instructions 512 may, for example, comprise program instructions for visually presenting video content via a display of user interface 504.

In accordance with an embodiment in which user device 102 includes a digital video recorder and/or player, program instructions 512 may, for example, comprise any of the following program instructions: (i) program instructions for visually presenting video content via a display of user interface 504, and (ii) program instructions for storing at data storage device 506 video content received via communication interface 502.

In accordance with an embodiment in which user device 102 includes a digital audio recorder and/or player, program instructions 512 may, for example, comprise any of the following program instructions: (i) program instructions for aurally presenting audio content via a loud speaker of user interface 504, and (ii) program instructions for storing at data storage device 506 audio content received via communications interface 502. Other examples of program instructions 512 are also possible.

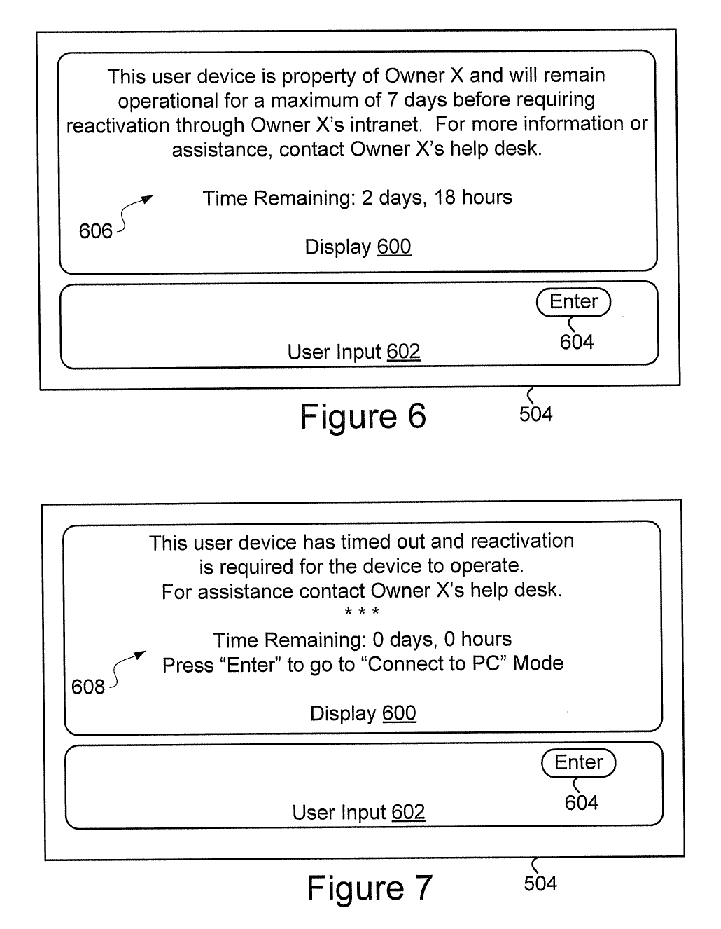

Next, FIGS. 6 and 7 illustrate details of user interface 504 and exemplary messages displayable by user interface 504. As illustrated in FIGS. 6 and 7, user interface 504 includes a display 600 and a user input 602. Display 600 may comprise any of a variety of displays, such as a liquid crystal display (LCD), a plasma display, a cathode ray tube (CRT) display, or some other type of display. User input 602 may comprise any of a variety of mechanisms operable by a user to input data into user device 102. As an example, user input 602 may include a keyboard, such as a QWERTY keyboard including an enter-key 604. Other examples of display 600 and user input 602 are also possible.

Display 600 is operable to visually present video content. For example, display 600 may be operable to present video content comprising messages generated in response to processor 500 determining whether expiration indicator 408 is expired and/or in response to rendering program instructions 512 as executable or non-executable. As another example, display 600 may be operable to present video content comprising images associated with the functions carried out by processor 500 executing program instructions 512. In this regard, the video content may, for example, comprise graphical images representing voltage, resistance, or current measurements, oscilloscope patterns, or automotive diagnostic trouble codes.

FIG. 6 illustrates display 600 presenting an exemplary message 606 for indicating that program instructions 512 are rendered as executable. Message 606 is displayable in response to processor 500 determining that expiration indicator 408 is not expired and/or in response to processor 500 rendering program instructions 512 as executable. Display 600 may periodically (e.g., hourly) decrement the time remaining portion of message 606. A person having ordinary skill in the art will understand that the time remaining portion of message 606, 608 may include other units of time (e.g., minutes and/or seconds) in addition to or as an alternative to days and/or hours.

FIG. 7 illustrates display 600 presenting an exemplary message 608 for indicating that program instructions 512 are rendered as non-executable. Message 608 is displayable in response to processor 500 determining that expiration indicator 408 has expired and/or processor 500 rendering program instructions 512 as non-executable. Other examples of messages for indicating that program instructions 512 are rendered as executable or non-executable are also possible.

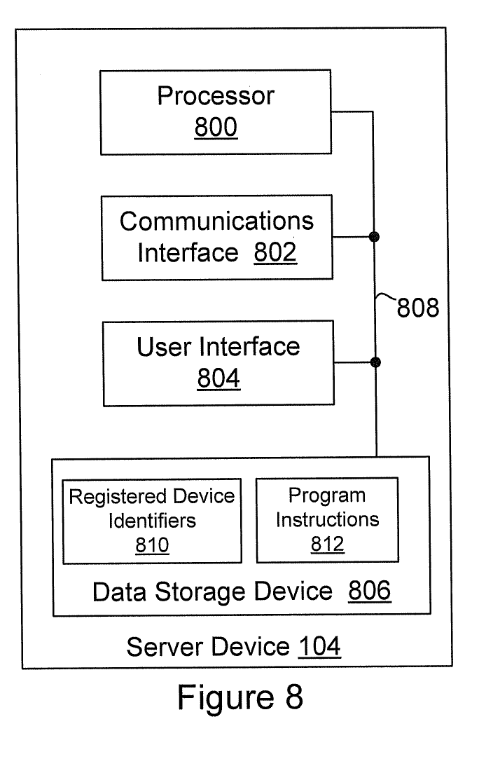

Next, FIG. 8 is a block diagram that illustrates details of server device 104. As illustrated in FIG. 8, server device 104 includes a processor 800, a communications interface 802, a user interface 804, and a data storage device 806, all of which may be linked together via a system bus, network, or other connection mechanism 808.

Processor 800 may comprise one or more general purpose processors and/or one or more special purpose processors. Processor 800 may execute computer-readable program instructions 812 that are stored at data storage device 806.

Communications interface 802 may carry out various communications, and may include a NIC to do so. The communications carried out via communications interface 802 may include communications interface 802 receiving from network 106 an access-token request (e.g., access-token request 300) transmitted from user device 102 or intermediary device 112. The communications carried out via communications interface 802 may also include communications interface 802 transmitting an access-token (e.g., access-token 400) to network 106 for subsequent transmission to user device 102 and/or to intermediary device 112.

User interface 804 may be arranged in various configurations. As an example, user interface 804 may be arranged as (i) a display for displaying a graphical user interface, and (ii) a keyboard and/or mouse that connects to server device 104 via a wired or wireless connection. User interface 804 may be operable by a user to enter data that is subsequently used by processor 800 and/or that is stored at data storage device 806. This data may, for example, comprise a device identifier that identifies a given device, such as user device 102 or intermediary device 112. Data storage device 806 may store the device identifier entered via user interface 804 within registered device identifiers 810. Registered device identifiers 810 may include one or more device identifiers, some of which may be arranged as and/or used as device identifiers 302, 304.

Data storage device 806 comprises a computer-readable storage medium readable by processor 800. The computer-readable storage medium may comprise volatile and/or non-volatile storage components, such as optical, magnetic, organic or other memory or disc storage, which can be integrated in whole or in part with processor 800.

Data storage device 806 may contain various data, such as registered device identifiers 810 and computer-readable program instructions 812. Preferably, registered device identifiers 810 includes a registered device identifier for each device for which server device 104 is authorized to provide access-tokens. As indicated above, device identifiers stored within registered device identifiers 810 may have been entered via user interface 804. Additionally or alternatively, one or more of the device identifiers stored within registered device identifiers 810 may have been received at server device 104 via communications interface 802.

Program instructions 812 may comprise various program instructions. As an example, program instructions 812 may include program instructions that cause processor 800 to determine whether a device identifier (e.g., device identifier 302 or device identifier 304) matches one of the registered device identifiers 810.

As another example, program instructions 812 may include instructions that cause processor 800 to generate an access-token (e.g., access-token 400) and to thereafter cause communications interface 802 to transmit the access-token to network 106 for transmission, in turn, to a destination identified by device identifier 402, device identifier 404, or a separate destination identifier (not shown). Processor 800 may execute these particular program instructions in response to determining that a device identifier within access-token request 300 matches one of the registered device identifiers 810.

The program instructions to generate an access-token may be executed multiple times so as to generate a plurality of access-tokens. Each access-token is preferably generated in response to server device 104 verifying that the device identifier(s) in a respective access-token request matches a device identifier in registered device identifiers 810. Each of the plurality of access-tokens includes a respective expiration indicator, and may, for example, be arranged as access-token 400. In one respect, the expiration indicator of each access-token of the plurality of access-tokens may indicate a common amount of time (e.g., 72 hours, 4,320 minutes, or 259,200 seconds). In another respect, the expiration indicator of one or more of the access-tokens of the plurality of access-tokens may indicate an amount of time that is different than an amount of time indicated by expiration indicator 408.

In accordance with an embodiment in which access-token request 300 includes a previously-generated access-token, execution of the program instructions to generate an access-token may include processor 800 modifying the previously-generated access-token (or at least a portion of the previously-generated access-token), and to include the modified token (or at the modified portion of the previously-generated access-token) within the access-token being generated. In this regard, if the previously-generated access-token includes an expired expiration indicator and/or a text file, execution of the program instructions to generate the access-token may include processor 800 modifying the expired expiration indicator (so that it is no longer expired) and/or the text file, and including the modified expiration indicator and/or modified text file within the access-token being generated.

As another example, program instructions 812 may include includes instructions that cause processor 800 to generate a notification message for notifying an unregistered device (e.g., another user device arranged as user device 102, but without its device identifier being stored within registered device identifiers 810) that an access-token request has been denied, and to cause communications interface 802 to transmit the notification message to network 106 for transmission, in turn, to the unregistered device. Processor 800 may execute these particular program instructions in response to determining that the one or more device identifiers contained in an access-token request do not match one of the registered device identifiers 810. In this regard, the access-token request may have been transmitted from the unregistered device.

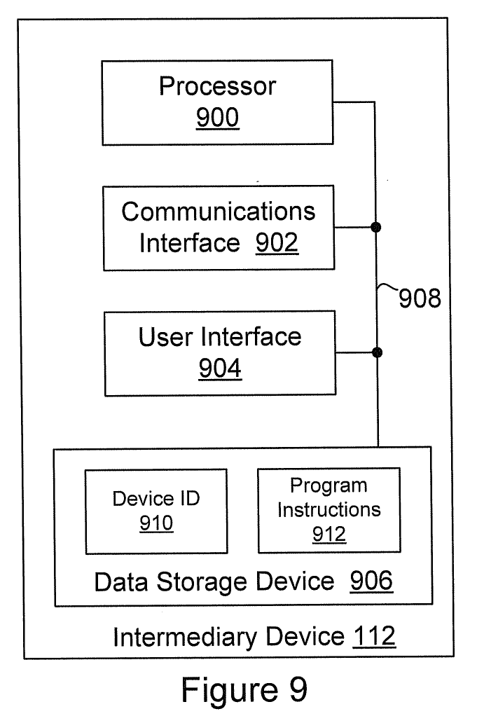

Next, FIG. 9 is a block diagram that illustrates details of intermediary device 112. As illustrated in FIG. 9, intermediary device 112 includes a processor 900, a communications interface 902, a user interface 904, and a data storage device 906, all of which may be linked together via a system bus, network, or other connection mechanism 908. Communications interface 902 may interface directly to communication links 114, 116 and indirectly to user device 102, server device 104, and network 106.

Processor 900 may comprise one or more general purpose processors and/or one or more special purpose processors. Processor 900 may execute computer-readable program instructions 912 that are stored at data storage device 906.

Data storage device 906 comprises a computer-readable storage medium readable by processor 900. The computer-readable storage medium may comprise volatile and/or non-volatile storage components, such as optical, magnetic, organic or other memory or disc storage, which can be integrated in whole or in part with processor 900.

Data storage 906 may contain various data, such as a device identifier 910 and computer-readable program instructions 912. Device identifier 910 may identify intermediary device 112, and may, for example, be arranged as device identifier 304 and/or device identifier 404. Device identifier 910 may include an IP address of intermediary device 112 for use as source identifier 406.

Program instructions 912 may comprise various program instructions. As an example, program instructions 912 may comprise instructions that cause processor 900 to determine a device identifier that identifies user device 102 (e.g., device identifier 302). Processor 900 may execute these instructions in response to communications interface 902 receiving an access-token request from user device 102. Processor 900 may determine the device identifier that identifies user device 102 from the access-token request.

As another example, program instruction 912 may include instructions that cause communications interface 902 to generate and then transmit an access-token request (e.g., access-token request 300) to network 106 for transmission, in turn to server device 104. Communications interface 902 may receive an access-token (e.g., access-token 400) in response to transmitting the access-token request. As yet another example, program instructions 912 may include instructions that cause communications interface 902 to transmit the received access-token (e.g., access-token 400) or at least a portion of the received access-token to user device 102.

User interface 904 may include a display for visually presenting visual content to a user of intermediary device 112. The display may display the visual content as a graphical user interface. For example, the graphical user interface may include a visually-presentable segment in which the user may enter an identifier to be used as device identifier 404 (e.g., a PIN and/or a user name and password), and a visually-presentable trigger segment that may be selected by the user to cause communications interface 902 to transmit access-token request 300. Other examples of visual content presentable via intermediary device 112 are also possible.

### 3. Exemplary Operation

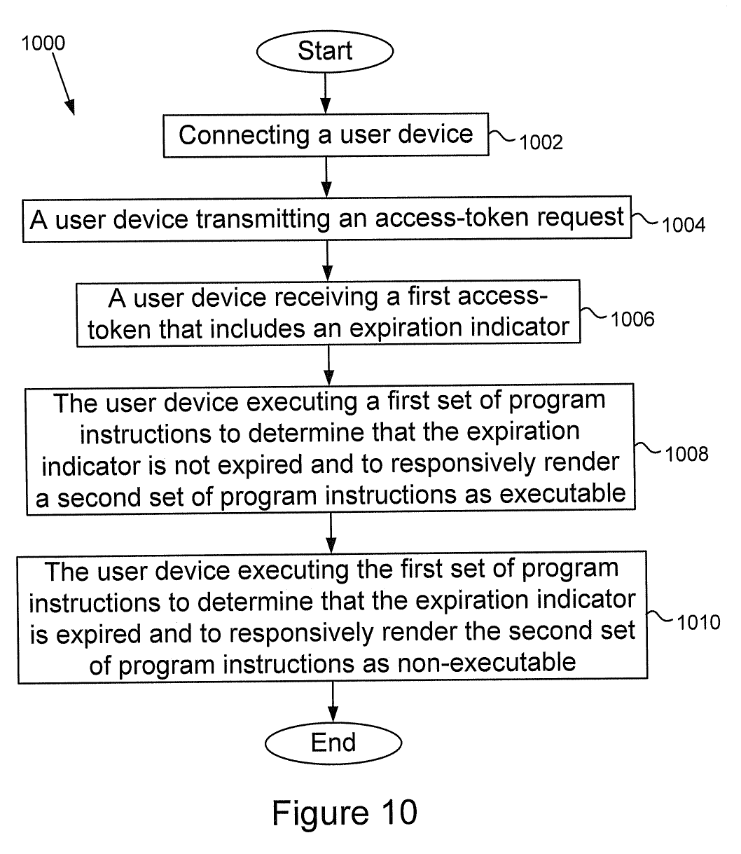

FIG. 10 is a flow chart illustrating a set of functions 1000 of an exemplary method that may be carried out in accordance with an exemplary embodiment, such an embodiment including system 100 or system 200.

Block 1002 includes connecting a user device (e.g., user device 102). By way of example, connecting the user device may be carried after a given person has requested to borrow or rent the user device from the user device's owner.

In accordance with an embodiment including system 100, connecting the user device may include (i) connecting user device 102 to communication link 108, network 106, or server device 104, and/or (ii) establishing a communication session (e.g., a wireless communication session) between user device 102 and server device 104.

In accordance with an embodiment including system 200, connecting the user device may include (i) connecting user device 102 to communication link 116 or intermediary device 112, and/or (ii) establishing a communication session (e.g., a wireless communication session) between user device 102 and intermediary device 112.

Next, block 1004 includes a user device (e.g., user device 102) transmitting an access-token request. In accordance with an embodiment including system 100, user device 102 may transmit the access-token request to server device 104 or to network 106 for transmission, in turn, to server device 104. The transmitted access-token request may, for example, include access-token request 300 except that the access-token request may not include device identifier 304.

In accordance with an embodiment including system 200, user device 102 may transmit an access-token request to intermediary device 112, and intermediary device 112 may transmit access-token request 300 to server device 104 via server 106. The access-token request transmitted by user device 102 to intermediary device 112 may be similar to request 300 except that the access-token request may not include device identifier 304.

Next, block 1006 includes the user device (e.g., user device 102) receiving an access-token (e.g., access-token 400) that includes an expiration indicator (e.g., expiration indicator 408). In particular, communications interface 502 may receive the access-token and thereafter provide the access-token to processor 500. Processor 500 may execute a portion of program instructions 510 to cause data storage 506 to store the received access-token (or a portion of the access token, such as the expiration indicator 408) within access-token data 514.

In accordance with an embodiment including system 100, server device 104 may generate access-token 400 and transmit the access-token to network 106 for transmission to user device 102. In accordance with an embodiment including system 200, server device 104 may generate access-token 400 and transmit access-token 400 to network 106 for transmission to intermediary device 104. Thereafter, intermediary device 104 may transmit access-token 400 to user device 102.

Next, block 1008 includes the user device (e.g., user device 102) executing a first set of program instructions (e.g., program instructions 510 or a portion of program instructions 510) to determine that an expiration indicator (e.g., expiration indicator 408) is not expired and to responsively render a second set of program instructions (e.g., program instructions 512) as executable. While program instruction 512 are rendered as executable, processor 500 may execute any portion of program instructions 510, 512.

Next, block 1010 includes the user device (e.g., user device 102) executing the first set of program instructions (e.g., program instructions 510) to determine that the expiration indicator (e.g., expiration indicator 408) is expired and to responsively render the second set of program instructions as non-executable. While program instruction 512 are rendered as non-executable, user device 102 and/or processor 500 prohibits execution of program instructions 512. Additionally, while program instructions 512 are rendered as non-executable, user device 102 and/or processor 500 may execute program instructions 510.

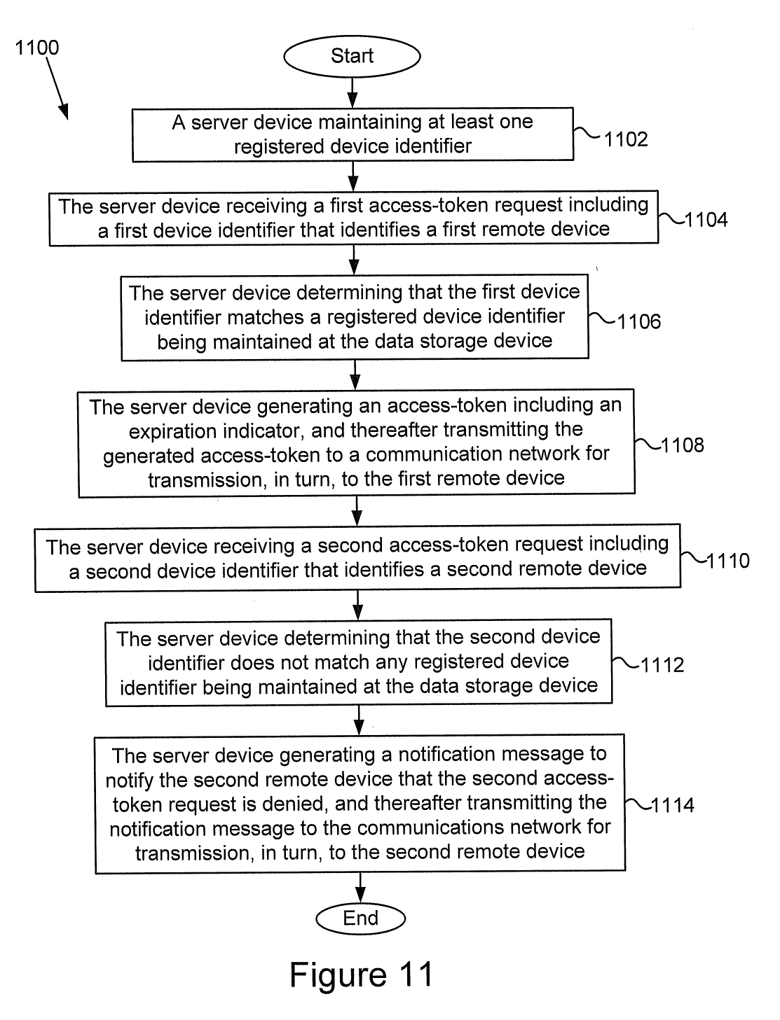

Turning to FIG. 11, this figure is a flow chart illustrating a set of functions 1100 of an exemplary method that may be carried out in accordance with an exemplary embodiment, such an embodiment including system 100 or system 200.

Block 1102 includes a server device (e.g., server device 104) maintaining at least one registered device identifier. Server device 104 may receive device identifiers via communications interface 802, user interface 804, or both communications interface 802 and user interface 804. Processor 800 may execute program instructions within program instructions 812 to cause the received device identifiers to be maintained at data storage device 806 as registered device identifiers 810.

The registered device identifiers 810 may include device identifiers that are configured similar to the device identifiers that identify user device 102 and intermediary device 112, e.g., device identifier 302 and device identifier 304, respectively. As an example, the registered device identifiers 810 may comprise any one or more of the following identifiers that identify and/or that are associated with a user device or an intermediary device: (i) an IP address, (ii) a media access control (MAC) address, (iii) a personal identification number (PIN), (iv) a user name and password, (v) a uniform resource locator (URL) for a given network domain, (vi) a disc drive serial number, and (vii) a license number. As another example, the at least one registered device identifier may include a plurality of consecutive IP addresses, such as a range of IP address from 191.145.0.0 to 191.145.255.0 or another range of IP addresses.

Additionally, data storage device 806 may maintain unregistered device identifiers (not shown). The device identifier of a user device reported as being stolen may be switched from being a registered device identifier to being an unregistered device identifier. In the case in which server device 104 receives an access-token request including a device identifier that matches an unregistered device identifier, the server device may execute program instructions to notify the device that sent the access-token request that the request has been denied.

Next, block 1104 includes the server device (e.g., server device 104) receiving a first access-token request (e.g., access-token request 300) including a first device identifier that identifies a first remote device (e.g., user device 102 or intermediary device 112). After receiving the first device identifier, processor 800 may cause data storage device 806 to maintain data that is associated with server device 104 receiving the first access-token request, such as the first access-token, a portion of the first access-token, and a time-stamp of when server device 104 receives the first access-token. Such data may be included within a report subsequently generated by server device 104 so as to identify which user devices of a plurality of user devices and which intermediary devices of a plurality of intermediary devices are requesting access-tokens.

Next, block 1106 includes the server device (e.g., server device 104) determining that the first device identifier matches a registered device identifier being maintained at the data storage device (e.g., data storage device 806). Processor 800 may execute program instructions within program instructions 812 to make this determination.

Next, block 1108 includes the server device (e.g., server device 104) generating an access-token (e.g., access-token 400) including an expiration indicator, and thereafter transmitting the generated access-token to a communications network (e.g., network 106) for transmission in turn to the first remote device. In an alternative embodiment, after generating the access-token and prior to transmitting the generated access-token, the server device may encrypt the generated access-token. In accordance with this alternative embodiment, the first remote device decrypts the encrypted generated access-token so as to recover the generated access-token.

Next, block 1110 includes the server device (e.g., server device 104) receiving a second access-token request including a second device identifier that identifies a second remote device. The second remote device may comprise another user device arranged as user device 102 or another intermediary device arranged as intermediary device 112. The second remote device may be connected to network 106, to intermediary device 112, or to the other intermediary device.

Processor 800 may cause data storage device 806 to maintain data that is associated with the server device 104 receiving the second access-token request, such as the second access-token, a portion of the second access-token, and a time-stamp of when server device 104 receives the second access-token. This data may be included within the report generated by server device 104.

Next, block 1112 includes the server device (e.g., server device 104) determining that the second device identifier does not match any registered device identifier being maintained at the data storage device (e.g., data storage device 806). Making this determination may include server device 104 determining that the second device identifier matches an unregistered device identifier being maintained at data storage device 806. Processor 800 may execute program instructions within program instructions 812 to make these determinations.

Next, block 1114 includes the server device (e.g., server device 104) generating a notification message (e.g., message 610) to notify the second remote device that the second access-token request is denied, and thereafter transmitting the notification message to the communications network (e.g., network 106) for transmission, in turn, to the second remote device.

Returning to block 1106, if the server device alternatively determines that the first device identifier does not match a registered device identifier, the server device may, thereafter, generate a notification message (e.g., message 610) to notify the first remote device that the first access-token request is denied, and the communications interface 802 may transmit the notification message to network 106 for transmission, in turn, to the first remote device. In accordance with this alternative arrangement, the functions of block 1108 would not be carried out in response to the server device receiving the first device identifier.

Returning to block 1112, if server device 104 alternatively determines that the second device identifier matches a registered device identifier being maintained at data storage device 606, then server device 104 may generate another access-token and thereafter transmit the other access-token to the communications network 106 for transmission in turn to the second remote device.

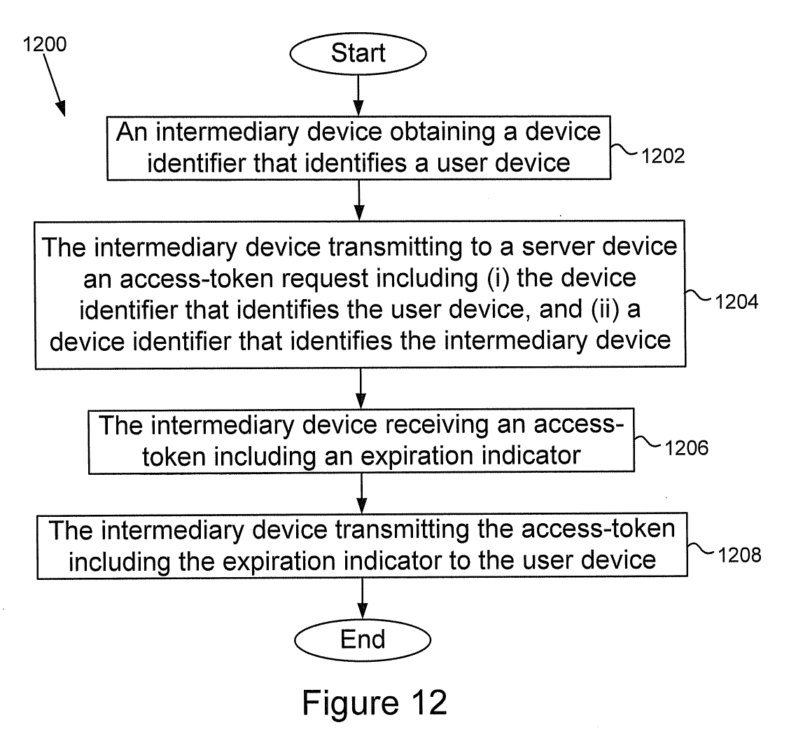

Turning to FIG. 12, FIG. 12 is a flow chart illustrating a set of functions 1200 of an exemplary method that may be carried out in accordance with an exemplary embodiment, such an embodiment including system 100 or system 200.

Block 1202 includes an intermediary device (e.g., intermediary device 112) obtaining a device identifier (e.g., device identifier 302) that identifies a user device (e.g., user device 102). The intermediary device may obtain the device identifier from an access-token request (e.g., access-token request 300) transmitted from the user device to the intermediary device.

Next, block 1204 includes the intermediary device (e.g., intermediary device 112) transmitting to a server device (e.g., server device 104) an access-token request (e.g., access-token request 300) including (i) the device identifier that identifies the user device, and (ii) a device identifier that identifies the intermediary device (e.g., device identifier 304). Processor 900 may execute program instructions within program instructions 912 to cause communications interface 902 to transmit the access-token request.

Next, block 1206 includes the intermediary device (e.g., intermediary device 112) receiving an access-token (e.g., access token 400) including an expiration indicator (e.g., expiration indicator 408). Receiving the access-token may include communications interface 902 receiving the access-token from server device 104 via network 106. Upon receiving the access-token, communications interface 902 may provide the access-token or at least a portion of the access-token to processor 900 and/or data storage device 906.

Next, block 1208 includes the intermediary device (e.g., intermediary device 112) transmitting the access-token (e.g., access token 400) including an expiration indicator (e.g., expiration indicator 408) to the user device (e.g., user device 102). In particular, communications interface 902 may transmit the access-token. After receiving the access-token, the user device may use the expiration indicator to determine whether a set of computer-readable program instructions (e.g., program instructions 512) should be rendered as executable or as non-executable.

### 4. Conclusion

Example embodiments arranged as a system and method are described above. Those skilled in the art will understand, however, that changes and modifications may be made to these examples without departing from the true scope and spirit of the described systems and methods. The embodiments described in this description and the accompanying drawings are set forth for illustration and not as a limitation.

We claim:

1. At a user device comprising a data storage device containing a first set of computer-readable program instructions and a second set of computer-readable program instructions, a method comprising:
the user device receiving a first access-token that includes an expiration indicator;
after receiving the first access-token, the user device executing the first set of program instructions to determine that the expiration indicator is not expired and to responsively render the second set of program instructions as executable; and
thereafter, the user device executing the first set of program instructions to determine that the expiration indicator is expired and to responsively render the second set of program instructions as non-executable.

2. The method of claim 1, wherein prior to the user device receiving the first access-token, the method further comprises:
connecting the user device to an intermediary device, wherein the intermediary device is associated with a first device identifier;
the intermediary device transmitting to a server device the first device identifier and an access-token request;
the intermediary device receiving the first access-token from the server device; and
the intermediary device transmitting the first access-token to the user device.

3. The method of claim 2, wherein prior to the intermediary device receiving the first access-token from the server device, the method further comprises:
the server device receiving the first device identifier and the access-token request;
the server device confirming that the received first device identifier is registered with the server device and thereafter generating the first access-token; and
the server device transmitting the first access-token to the intermediary device.

4. The method of claim 3,
wherein the user device is associated with a second device identifier,
the method further comprising:
prior to the server device generating the first access-token, the intermediary device transmitting the second device identifier to the server device;
the server device storing data that associates the access-token request with the first device identifier and the second device identifier; and
the server device using the stored data to generate a report that indicates how many access-token requests were received by the server device and which devices are associated with each of the received access-token requests.

5. The method of claim 2, wherein the first device identifier is selected from the group consisting of (i) an internet protocol (IP) address, (ii) a media access control (MAC) address, (iii) a personal identification number (PIN), (iv) a user name and password, (v) a uniform resource locator for a given network domain, (vi) a disc drive serial number, and (vii) a license number associated with the intermediary device.

6. The method of claim 1, wherein the expiration indicator comprises data representing (i) an amount of time, (ii) a time of day, (iii) a calendar date, or (iv) the time of day and the calendar date.

7. The method of claim 1,
wherein the first access-token further includes a list of the second set of computer-readable program instructions, and
wherein the user device identifies the second set of computer-readable program instructions from the list.

8. The method of claim 1,
wherein, while the second set of program instructions are rendered as executable, the method further comprises the user device executing at least a portion of the second set of program instructions, and
wherein, while the second set of program instructions are rendered as non-executable, the method further comprises the user device prohibiting execution of the second set of program instructions.

9. A user device comprising:
a communications interface operable to receive an access-token that includes an expiration indicator;
a data storage device that contains a first set of computer-readable program instructions and a second set of computer-readable program instructions; and
a processor that is operable to execute the first set of program instructions and the second set of program instructions,
wherein the first set of program instructions includes program instructions that cause the processor to (i) determine whether the expiration indicator is expired, (ii) render the second set of program instructions as executable if the processor determines that the expiration indicator is not expired, and (iii) render the second set of program instructions as non-executable if the processor determines that the expiration indicator is expired.

10. The user device of claim 9, further comprising:
a user interface,
wherein, if the second set of program instructions are rendered as executable, the user interface is operable to display a message that indicates the second set of program instructions are rendered as executable, and
wherein, if the second set of program instructions are rendered as non-executable, the user interface is operable to display a message that indicates the second set of program instructions are rendered as non-executable.

11. The user device of claim 9,
wherein the data storage device further contains a device identifier that identifies the user device,
wherein the communications interface connects to an intermediary device and is operable to transmit the device identifier to the intermediary device,
wherein the intermediary devices transmits to a server device the device identifier and an access-token request, and the server device thereafter generates the access-token and transmits the access-token to the intermediary device, and
wherein the intermediary device transmits the access-token to the communications interface after receiving the access-token from the server device.

12. The user device of claim 9, wherein the second set of computer-readable program instructions includes program instructions that are executable for servicing a vehicle that transports one or more persons.

13. At a server device comprising a data storage device, a method comprising:
at the data storage device, maintaining at least one registered device identifier;
the server device receiving a first access-token request including a first device identifier that identifies a first remote device;
the server device determining that the first device identifier matches a registered device identifier being maintained at the data storage device;
after the server device determines that the first device identifier matches a registered device identifier being maintained at the data storage device, the server device generating an access-token including an expiration indicator, and thereafter transmitting the generated access-token to a communications network for transmission, in turn, to the first remote device.

14. The method of claim 13, wherein the first remote device is selected from the group consisting of (i) a user device, and (ii) an intermediary device that connects to the user device.

15. The method of claim 13, wherein the user device comprises a handheld diagnostic tool and the intermediary device comprises a personal computer.

16. The method of claim 13, further comprising:
the server device receiving a second access-token request including a second device identifier that identifies a second remote device;
the server device determining that the second device identifier does not match a registered device identifier being maintained at the data storage device; and
after the server device determines that the second device identifier does not match any registered device identifier being maintained at the data storage device, the server device responsively generating a notification message to notify the second remote device that the second access-token request is denied, and thereafter transmitting the notification message to the communications network for transmission, in turn, to the second remote device.

17. The method of claim 16, further comprising:
the server device causing the data storage device to maintain data that is associated with (i) the server device receiving the server device receiving the first access-token request including the first device identifier, and (ii) the server device receiving the second access-token request including the second device identifier; and
the server device generating a report that includes the data that is associated with (i) the server device receiving the server device receiving the first access-token request including the first device identifier, and (ii) the server device receiving the second access-token request including the second device identifier.

18. The method of claim 13, further comprising:
the server device encrypting the generated access-token prior to transmitting the generated access-token to the communications network,
wherein the first remote device decrypts the encrypted generated access-token to recover the generated access-token.

19. The method of claim 13,
wherein the first remote device comprises an intermediary device that connects to the communications network and to a user device,
wherein the user device is associated with a second device identifier,
the method further comprising:
the server device receiving the second device identifier; and
prior to the server device generating the access-token, the server device determining that the second device identifier matches another device identifier that is being maintained at the data storage device as a registered device identifier.

20. The method of claim 13, wherein maintaining at least one registered device identifier includes maintaining a plurality of consecutive internet protocol (IP) addresses.

21. The method of claim 13, further comprising:
the server device generating one or more other access-tokens,
wherein each of the one or more other access-tokens includes a respective expiration indicator, and
wherein the expiration indicator included within the access-token and the respective expiration indicator included in each of the one or more other access-tokens indicates a common amount of time.

22. The method of claim 13, further comprising:
the server device generating one or more other access-tokens,
wherein each of the one or more other access-tokens includes a respective expiration indicator,
wherein the expiration indicator included within the access-token indicates a first amount of time, and
wherein the respective expiration indicator included in at least one of the one or more other access-tokens indicates a second amount of time that is different than the first amount of time.

23. A server device comprising:
a processor;
a data storage device that contains computer-readable program instructions and at least one registered device identifier; and
a communications interface that is operable to receive a first access-token request including a first device identifier,
wherein the first device identifier identifies a first remote device, and
wherein the computer-readable program instructions comprise program instructions that are executable by the processor to (i) determine that the first device identifier matches a registered device identifier contained at the data storage device, and responsively generate a first access-token that includes an expiration indicator, and (ii) cause the communications interface to transmit the first access-token to a communications network for transmission, in turn, to the first remote device.

24. The server device of claim 23,
wherein the communications interface is further operable to receive a second device identifier and a second access-token request,
wherein the second device identifier identifies a second remote device,
wherein the computer-readable program instructions comprise program instructions that are executable by the processor to (i) determine that the second device identifier does not match a registered device identifier contained at the data storage device, and responsively generate a notification message to notify the second remote device that the second access-token request has been denied, and (ii) cause the communications interface to transmit the notification message to the communications network for transmission, in turn, to the second remote device.

25. The server device of claim 23,
wherein the first access-token request comprises a second access-token,
wherein generation of the second access-token occurs prior to generation of the first access-token,
wherein execution of the program instructions to responsively generate the first access-token causes the processor to modify the second access-token, and
wherein the first access-token comprises the modified second access-token.

26. The server device of claim 25,
wherein the second access-token comprises a text file,
wherein the processor modifies the second access-token by modifying the text file, and
wherein the modified second access-token comprises the modified text file.

27. At an intermediary device that interfaces to a user device and to a server device, a method comprising:
the intermediary device obtaining a device identifier that identifies the user device;
the intermediary device transmitting to the server device an access-token request including (i) the device identifier that identifies the user device, and (ii) a device identifier that identifies the intermediary device;
the intermediary device receiving from the server device an access-token including an expiration indicator; and
the intermediary device transmitting the access-token including the expiration indicator to the user device,
wherein the user device uses the expiration indicator to determine whether a set of computer-readable program instructions maintained at the user device should be rendered as executable or as non-executable.

28. The method of claim 27, wherein prior to the intermediary device receiving the access-token from the server device, the method further comprises:
the intermediary device receiving from the user device an access-token that includes an expired expiration indicator; and
the intermediary device transmitting to the sever device the access-token that includes the expired expiration indicator.

29. The method of claim 27, wherein the device identifier that identifies the intermediary device is maintained as a registered device identifier at a data storage device accessible to the server device.

30. An intermediary device comprising:
a communications interface that interfaces to a user device and to a server device;
a processor; and
a data storage device that contains a first device identifier and computer-readable program instructions that are executable by the processor,
wherein the first device identifier identifies the intermediary device,
wherein the computer-readable program instructions include instructions that (i) cause the processor to determine a second device identifier that identifies the user device, (ii) cause the communications interface to transmit to the server device the first device identifier, the second device identifier, and an access-token request, and (iii) cause the communications interface to transmit to the user device an access-token that is received by the communications interface after the communications interface transmits to the server device the access-token request,
wherein the received access-token includes an expiration indicator, and
wherein the user device uses the expiration indicator to determine whether a set of computer-readable program instructions maintained at the user device should be rendered as executable or as non-executable.
